(19) United States
(12) Patent Application Publication
(10) Pub. No.: US 2024/0338704 A1
(43) Pub. Date: Oct. 10, 2024

(54) SYSTEMS AND METHODS FOR DETECTING POINTS OF COMPROMISE

(71) Applicant: U.S. Bancorp, National Association, Minneapolis, MN (US)

(72) Inventors: Christopher Kallas, Grafton, WI (US); Xiaoqiao Wei, Woodbury, MN (US); Wentao Lu, Minnetonka, MN (US)

(73) Assignee: U.S. Bancorp, National Association, Minneapolis, MN (US)

(21) Appl. No.: 18/298,037

(22) Filed: Apr. 10, 2023

(51) Int. Cl. G06Q 20/40; G06Q 20/38

(52) U.S. Cl. CPC G06Q 20/4016; G06Q 20/389

(57) ABSTRACT

A system for maintaining data integrity includes a network interface and a processor coupled to memory. The processor can be configured to receive, via the network interface and from one or more computing devices, data regarding a plurality of transactions performed at a plurality of locations; generate, from the data, a data structure comprising a plurality of rows; for each of the plurality of locations, determine a ratio of a count of rows of a subset of rows for a location that each include an indication of a fraudulent transaction to a count of rows of the plurality of rows for the location; determine a location from the plurality of locations is a point of compromise based on the ratio for the location; and generate a record comprising a stored association between an identification of the location and an identification indicating a point of compromise responsive to the determination.

### BACKGROUND

Credit and debit cards play a major role in financial transactions throughout the world. However, traditional credit and debit cards struggle with a number of drawbacks. For example, the magnetic stripe information can be compromised by a skimmer device placed in a point-of-sale location or card information can be stolen using a malware breach in a merchant's system. Compromised cards can then be used for fraudulent transactions. Failure to timely detect a point of compromise where card information is illegitimately obtained can result in more and more cards being used for fraud. Such activity can cause significant business loss to card issuers. Furthermore, such fraud damages the trust and relationships between card issuers and customers.

To detect points of compromise, a system can process data for thousands to millions of transactions performed at different locations. Each transaction can correspond to a unique set of attributes or data. The proliferation of storage and network devices can enable a large amount of data to be exchanged and stored. However, given the large number of transactions and data corresponding to the transactions, detecting points of compromise can require a substantial amount of computer resources.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is an illustration of an example system for detecting points of compromise, in accordance with an implementation;

FIG. 2 is an illustration of an example method for detecting points of compromise, in accordance with an implementation;

FIG. 3 is an illustration of an example data structure for detecting points of compromise, in accordance with an implementation;

FIG. 4 is an example sequence for filtering locations to detect points of compromise, in accordance with an implementation; and

FIGS. 5-9 are example graphs illustrating counts of compromised cards for different locations over different time windows, in accordance with an implementation.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

As previously mentioned, detecting points of compromise (e.g., locations, such as one or more point-of-sale devices or merchants, affected by a malicious entity that steals or copies transaction card information to use for transactions) can incur a substantial amount of computer resources given the large number of transactions that occur each day. A computer may attempt to detect such points of compromise using matrix data structures. For example, a computer can generate a matrix in which individual rows of the matrix correspond to unique transaction cards (e.g., debit cards or credit cards) that have been compromised. Columns of the matrix can correspond to unique locations at which the compromised transaction cards completed transactions. The computer can process the data in the matrix by comparing the values in the rows and columns together to identify locations at which the transaction cards of the matrix may have been compromised. The computer can add transaction cards to the matrix over time as the computer determines the cards have been compromised. Given the large number of transaction cards that perform transactions, processing and maintaining such matrices can require a significant amount of computer resources. An example of such a method of detecting points of compromise and manipulating a matrix to reduce the computational resources of detecting such points of compromise is described in U.S. Pat. No. 11,468,447, filed Sep. 6, 2019, the entirety of which is incorporated by reference herein.

A computer using the systems and method described herein can reduce the computational resources that are required to detect points of compromise compared to prior systems. For example, instead of using matrix data structures, the computer can use tables or dataframes (e.g., standard query language (SQL) tables or Python/R dataframes). In many cases, transaction data is placed and stored in tables or dataframes. Transferring the data from tables or dataframes to matrices requires extra computer processing resources. Therefore, using matrices to detect points of compromise may not be as efficient as directly using tables or dataframes.

A computer can generate and process a table or dataframe to detect or identify points of compromise. For example, a computer can generate a data structure (e.g., a table or dataframe) that includes rows and columns. Each column can correspond to values or attributes of transactions. The rows can correspond to different transactions. Each row can include an identification of a location, an identification of a card (e.g., a transaction card) that performed a transaction at the location, and a date of the transaction at the location. All or a subset of the rows can include an indication of a fraudulent transaction that occurred at a date or time subsequent to the date or time of the transaction of the row. Such rows can correspond to transactions by compromised cards. For individual locations, the computer can identify rows that include indications of fraudulent transactions and/or rows that do not include indications of fraudulent transactions. The computer can determine or calculate a ratio of rows with indications of fraudulent transactions to rows without dates of fraudulent transactions. The computer can compare the ratios for the locations to a threshold (e.g., a ratio threshold) and/or apply other criteria to the ratios to determine whether the locations are or could be locations at which the compromise of the cards occurred. The computer can determine and/or generate a list of locations with ratios that exceed the threshold or otherwise satisfy the criteria. The locations on the list can be lists of points of compromise or potential points of compromise. The computer can generate the list in a record (e.g., a file, document, table, listing, message, notification, etc.).

In some embodiments, the computer can use a sequence of filtering techniques to identify or detect points of compromise. For example, the computer can identify the locations with ratios that exceed the threshold as potential points of compromise. The computer can determine or identify the counts of rows with indications of fraudulent transactions for the locations on the list. The computer can determine such counts for different time windows for each location on the list (e.g., transactions by compromised cards). For each location, the computer can compare the counts for the different time windows between each other. The computer can identify locations with an increase in transactions by compromised cards compared to previous time windows as points of compromise or potential points of compromise.

From the locations that the computer identified an increase in transactions by compromised cards, the computer can further filter out locations by identifying cards that experience such an increase for multiple time windows. For example, the computer can compare counts of transactions by compromised cards of individual time windows to such counts for previous time windows. The computer can maintain and increment a counter (e.g., a frequency) for each time window for which the computer determined the count for the time window exceeds the counts of previous time windows. The computer can compare the counts of the counters for the remaining individual locations. The computer can identify a defined number of locations that have the highest counts to be points of compromise or potential points of compromise.

In some embodiments, the computer can further filter the locations to identify any points of compromise. For example, the computer can identify the locations of the defined number of locations identified as having the highest counts. The computer can retrieve the counts of the identified locations for the different time windows from which the computer determined the counts. The computer can apply one or more rules or criteria to the counts. If the counts for a location satisfy the one or more rules or criteria, the computer can determine the location is a point of compromise. Otherwise, the computer may determine the location is not a point of compromise. In some embodiments, the computer can generate graphs that illustrate the counts over time for each location. A reviewer can review the graphs and determine the locations that are points of compromise based on the graphs.

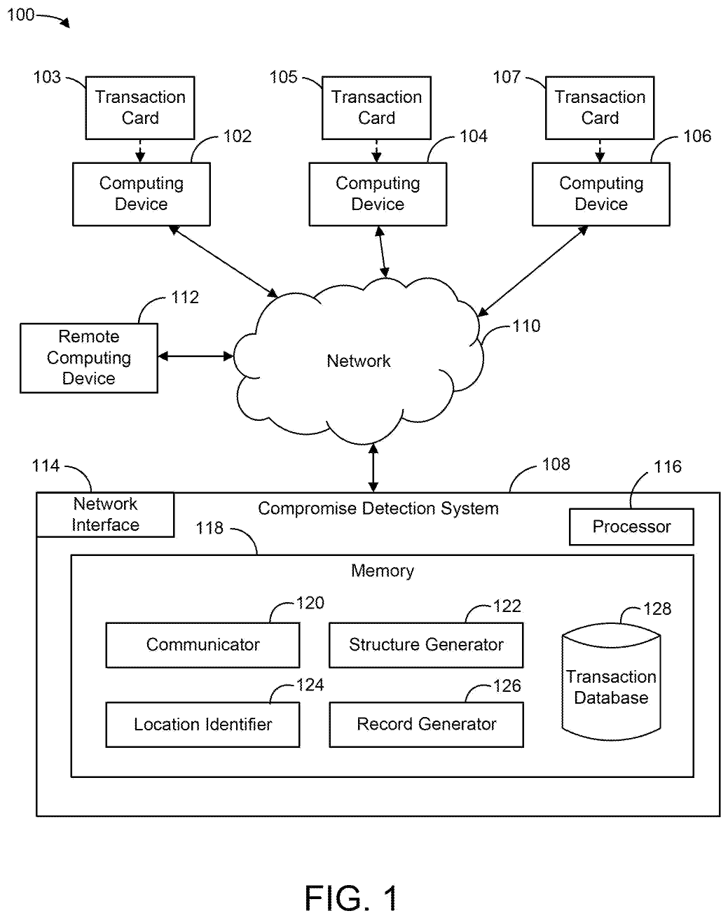

FIG. 1 illustrates an example system 100 for detecting points of compromise, in some embodiments. In brief overview, the system 100 can include computing devices 102, 104, and 106. The computing devices 102, 104, and 106 can communicate with a compromise detection system 108 over a network 110. The computing devices 102, 104, and 106 can do so by exchanging messages with the compromise detection system 108. The computing devices 102, 104, and 106 can transmit messages to the compromise detection system 108 that include transaction data for transactions that are performed at locations of or that correspond with the respective computing devices 102, 104, and 106. The compromise detection system 108 can generate and/or update a data structure using the transaction data. The compromise detection system 108 can process the data in the data structure to detect or identify computing devices or the locations associated with the computing devices that may have been compromised. Such locations can be points of compromise. The compromise detection system 108 can generate and/or transmit a record indicating the locations to a remote computing device 112. The system 100 may include more, fewer, or different components than shown in FIG. 1. For example, there may be any number of client devices or computers that make up or are a part of the compromise detection system 108 or networks in the system 100.

The computing devices 102-106, the compromise detection system 108, and/or the remote computing device 112 can include or execute on one or more processors or computing devices and/or communicate via the network 110. The network 110 can include computer networks such as the Internet, local, wide, metro, or other area networks, intranets, satellite networks, and other communication networks such as voice or data mobile telephone networks. The network 110 can be used to access information resources such as web pages, websites, domain names, or uniform resource locators that can be presented, output, rendered, or displayed on at least one computing device (e.g., the computing devices 102-106 and/or the remote computing device 112), such as a laptop, desktop, tablet, personal digital assistant, smartphone, portable computers, or speaker. For example, via the network 110, the computing devices 102, 104, and 106 can transmit data to the compromise detection system 108. The compromise detection system 108 can store the data in a data structure and use the stored data to determine whether the locations associated with the computing devices 102, 104, and 106 are points of compromise.

The computing devices 102-106, the compromise detection system 108, and/or the remote computing device 112 can include or utilize at least one processing unit or other logic devices such as a programmable logic array engine or a module configured to communicate with one another or other resources or databases. As described herein, computers can be described as computers, computing devices, or client devices. The computing devices 102-106 and/or the remote computing device 112 may each contain a processor and a memory. The components of the computing devices 102-106, the compromise detection system 108, and/or the remote computing device 112 can be separate components or a single component. The system 100 and its components can include hardware elements, such as one or more processors, logic devices, or circuits.

The computing devices 102-106 may be computing devices that are associated with individual locations. For example, the computing devices 102-106 can be point-of-sale devices at individual locations or devices that collect data (e.g., transaction data) from point-of-sale devices at individual locations. The computing devices 102-106 can be computing devices that operate at different financial institutions or different brick-and-mortar buildings. For example, the computing devices 102-106 can include a register at a brick-and-mortar store or a server in the cloud that facilitates transactions for online stores. The computing devices 102-106 can be configured to receive a request for an item purchase in a transaction. In some cases, such transactions can be performed by transaction cards 103, 105, and/or 107, which can be cards connected to an account and configured to perform transactions (e.g., perform transactions using near-field communication technology or swiping technology). The computing devices 102-106 can identify attributes of items (e.g., value, item type, number of items, etc.) and/or other attributes of transactions (e.g., time of the transaction, geographical location of the transaction, type of the transaction (e.g., online or at a brick-and-mortar store), total value of the transaction, etc.). The computing devices 102-106 can transmit the attributes (e.g., transaction attributes) of the transactions and/or identifiers of accounts (e.g., an identifier of the transaction card that was used to initiate the transaction) to the compromise detection system 108 or to another computing device which will transmit or forward the data to the compromise detection system 108.

The computing devices 102, 104, and/or 106 can be compromised or associated with a compromised location. For example, the computing devices 102, 104, and/or 106 can be compromised by a skimmer device that reads the magnetic strip information of transaction cards presented or used at the locations or the computing devices 102, 104, and/or 106 and transmit the information to a malicious actor. In another example, the computing devices 102, 104, and/or 106 can be compromised by malware software installed on the computing devices 102, 104, and/or 106 that captures account information from transaction cards and transmits the information to a malicious actor. Other types of devices and software besides skimmer devices and malware may be used to compromise transaction information at the locations that correspond with the computing devices 102, 104, and/or 106.

The compromise detection system 108 may comprise one or more processors that are configured to manage a point-of compromise detection environment for analyzing data received from the computing devices 102-106 to detect points of compromise. Based on the analysis, the compromise detection system 108 may determine the computing devices 102-106 and/or any number of other computing devices are associated with compromised locations or potentially compromised locations. The compromise detection system 108 may comprise a network interface 114, a processor 116, and/or memory 118. The compromise detection system 108 may communicate with the computing devices 102-106 via the network interface 114, which may be or include an antenna or other network device that enables communication across a network and/or with other devices. The processor 116 may be or include an ASIC, one or more FPGAs, a DSP, circuits containing one or more processing components, circuitry for supporting a microprocessor, a group of processing components, or other suitable electronic processing components. In some embodiments, the processor 116 may execute computer code or modules (e.g., executable code, object code, source code, script code, machine code, etc.) stored in memory 118 to facilitate the activities described herein. The memory 118 may be any volatile or non-volatile computer-readable storage medium capable of storing data or computer code.

The memory 118 may include a communicator 120, a structure generator 122, a location identifier 124, a record generator 126, and/or a transaction database 128, in some embodiments. In brief overview, the components 120-126 may cooperate to generate and/or maintain the transaction database 128 from transaction data that the components 120-126 receive from point-of-sale devices and/or otherwise regarding transactions performed at such point-of-sale devices. The components 120-126 can generate a table and/or dataframe from the transaction data in the transaction database 128. The components 120-126 can process the data in the table and/or dataframe to detect or identify compromised locations (e.g., locations that include one or more computing devices that have been compromised, such as by skimmer devices or malware).

The communicator 120 may comprise programmable instructions that, upon execution, cause the processor 116 to communicate with the computing devices 102-106, the remote computing device 112, and/or any other computing device. The communicator 120 may be or include an application programming interface (API) that facilitates communication between the compromise detection system 108 (e.g., via the network interface 114) and other computing devices. The communicator 120 may communicate with the computing devices 102-106 and/or the remote computing device 112 across the network 110.

The communicator 120 can establish connections with the computing devices 102-106 and/or the remote computing device 112. The communicator 120 can establish the connections with the computing devices 102-106 and/or the remote computing device 112 over the network 110. To do so, the communicator 120 can communicate with the computing devices 102-106 and/or the remote computing device 112 across the network 110. In one example, the communicator 120 can transmit syn packets to the computing devices 102-106 and/or the remote computing device 112 and establish the connections using a TLS handshaking protocol. The communicator 120 can use any handshaking protocol to establish connections with the computing devices 102-106.

The structure generator 122 may comprise programmable instructions that, upon execution, cause the processor 116 to generate, instantiate, or initialize a data structure (e.g., an initial data structure) that contains transaction data for transactions performed by or at individual point-of-sale devices. The structure generator 122 can generate a table (e.g., an SQL table) or a dataframe (e.g., a Python/R dataframe) from the transaction data. The structure generator 122 can generate the table or dataframe such that the table can be queryable for processing. The structure generator 122 can generate the table or dataframe to include one or more rows and/or one or more columns. Each row can correspond to a different transaction (e.g., each row can include transaction data for a different transaction). Each column can correspond to a different transaction attribute (e.g., each column can include values for a different transaction attribute). The structure generator 122 can receive (e.g., via the communicator 120) transaction data for individual transactions and store the values for the transactions in rows that correspond with the transactions.

The rows of the data structure can include values for different transaction attributes. For example, each row can correspond to a transaction and include an identification of a location (e.g., a computing device or identifier of an entity, such as a business or other organization) at which the transaction was performed, an identification (e.g., a numerical or alphanumerical string) of a card that performed the transaction at the location, and/or a date of the transaction at the location. The structure generator 122 can identify and/or retrieve such transaction data from the message or messages that the structure generator 122 receives regarding the transactions. The structure generator 122 can insert the identified or retrieved transaction data into the corresponding rows and columns of the data structure to generate the data structure.

The structure generator 122 can store indications of fraudulent transactions in the data structure. For example, the structure generator 122 can receive indications that individual transaction cards have been compromised. The indications can include dates of fraudulent transactions that were performed by the individual transaction cards (e.g., transactions that were reported to be fraudulent) and/or identifications of the transaction cards that were used to perform the fraudulent transactions. The structure generator 122 can receive such indications from an external computing device. Such an external computing device can automatically detect compromised transaction cards (e.g., based on a sudden change in transaction behavior) or from user inputs, such as when an individual calls an entity associated with a transaction card to report a compromised transaction card and/or fraudulent transactions performed with such a compromised transaction card. The structure generator 122 can receive the indications of compromised transaction cards and/or fraudulent transactions and identify the identifications of the transaction cards. The structure generator 122 can query the data structure for rows that include identifications of transaction cards that match identifications of compromised transaction cards. The structure generator 122 can insert an indication of a fraudulent transaction in the rows with matching identifications. In some cases, the structure generator 122 may only insert indications of fraudulent transactions in rows that includes dates for transactions prior to the respective fraudulent transactions.

The indication of a fraudulent transaction can be a date of the fraudulent transaction (e.g., a date in which the fraudulent transaction occurred or was first reported) or another value that indicates the card that was used in the transaction of the row was subsequently used to perform a fraudulent transaction. The date can be a date subsequent to the date of the transaction of the row in which the structure generator places the date. In some cases, the structure generator 122 can insert dates of fraudulent transactions in rows of transactions responsive to determining the dates are subsequent (e.g., later) than the dates of the transactions of the rows. For example, the structure generator 122 can generate a row for a transaction performed by a transaction card A. The structure generator 122 can insert a date of the transaction, an identification of transaction card A, and a location of the transaction in the row. The structure generator 122 can receive an indication that transaction card A was used to perform a transaction. The structure generator 122 can compare the date of the fraudulent transaction with the date in the row of the transaction performed by transaction card A. Based on the comparison, the structure generator 122 can determine the date of the fraudulent transaction is later than the date of the transaction of the row. Responsive to the determination, the structure generator 122 can insert an indication of the fraudulent transaction (e.g., the date of the fraudulent transaction or another value indicating a subsequent fraudulent transaction) in the row for the transaction performed by transaction card A. The structure generator 122 can similarly update each row of the data structure that contains an identification of transaction card A with a date prior to the date of fraudulent transaction. The structure generator 122 can similarly update any row of the data structure to indicate transactions used by transaction cards that were subsequently used for fraudulent transactions. Such transaction cards can be compromised transaction cards.

The structure generator 122 can update the data structure over time. For example, the structure generator 122 can receive transaction data for different transactions over time. For each transaction, the structure generator 122 can generate a row in the data structure and insert values for the transaction in the row. The structure generator 122 can update the rows over time to include indications of fraudulent transactions.

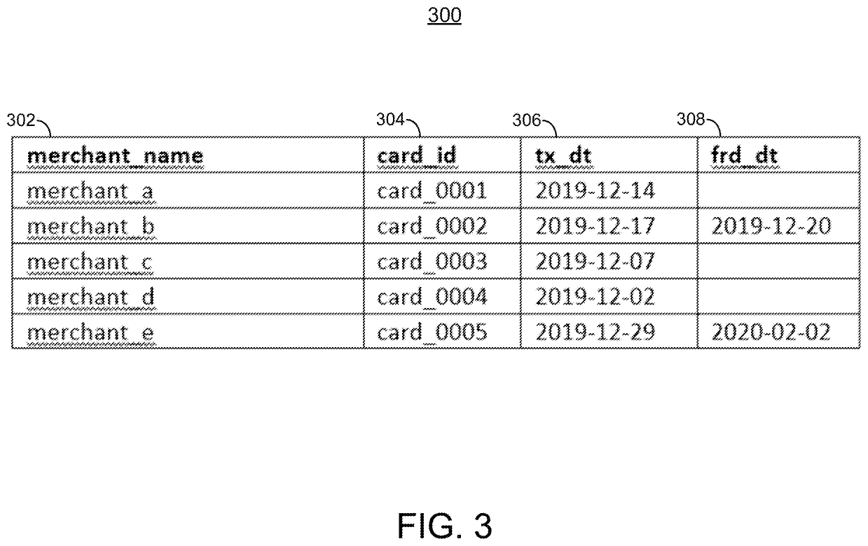

An example data structure 300 generated by the structure generator 122 is illustrated in FIG. 3. As illustrated in FIG. 3, the data structure 300 can include rows for individual transactions that are performed at different locations. The data structure 300 can include a location column 302 for identifications of different locations, a card column 304 for identifications of transaction cards, a transaction date column 306 for dates of transactions for the individual rows, and a fraud indication column 308 for indications of fraudulent transactions that occurred after the transactions of the rows. The location column 302 can include identifications of the locations in which the transactions were performed. The card column 304 can include identifications of the transaction cards that performed the transactions. The transaction date column 306 can include dates of the transactions. In some cases, the transaction date column 306 is optional. The fraud indication column 308 can include indications of whether a fraudulent transaction occurred after or subsequent to the transactions of the rows. The indications can be any value or a date of the fraudulent transaction. The values and/or dates of the data structure 300 can be in any format. The data structure 300 can include any number of rows for transactions, locations, and/or transaction cards.

The structure generator 122 can store the data structure in the transaction database 128. The transaction database 128 can be a graph or relational database. The transaction database 128 can store data for individual transactions in tables or dataframes. The transaction database 128 can store any number of data structures as tables or dataframes.

The location identifier 124 may comprise programmable instructions that, upon execution, cause the processor 116 to identify or detect points of compromise. A point of compromise can be a location at which data of a device was captured and/or stolen and provided to a malicious user. The location identifier 124 can be configured to analyze or process the data in the data structure generated by the structure generator 122 to identify or detect points of compromise.

In some embodiments, the location identifier 124 can detect points of compromise (POCs) using a multi-phase filtering process. For example, as described in detail herein, in a first phase, the location identifier 124 can select initial POC candidates by comparing compromised card ratios across different merchants. In a second phase, the location identifier 124 can monitor POC candidates over a series of time windows (e.g., time windows of a time period). The location identifier 124 can identify or detect the monitor POC candidates that have abrupt increases of compromised cards. In a third phase, the location identifier 124 can identify or select locations with frequent or consistent increases. In a fourth phase, the location identifier 124 can generate graphical representations or visualizations including the counts of transactions by compromised cards at the identified or selected locations. A reviewer (e.g., a human reviewer or an automated reviewer) can view the graphical or visual representations and determine which of the locations are points of compromise.

The location identifier 124 can determine ratios (e.g., compromised card ratios) for individual locations. The location identifier 124 can determine the ratios for each location that corresponds to a transaction in the data structure (e.g., the locations for which the data structure stores identifications in rows for transactions in the data structure). The ratio for a location can be a ratio of a count of rows for transactions performed at the location that include an indication of a fraudulent transaction (e.g., a count of the rows of the data structure that contain or include an identification of the location and an indication of a fraudulent transaction) to a count of rows of the data structure that correspond to transactions performed at the location (e.g., a count of the rows of the data structure that contain or include the identification of the location). The location identifier 124 can maintain and increment a counter for each count to determine the ratio for the location. The location identifier 124 can similarly determine a ratio for each location identified in the data structure (e.g., with an identification in the data structure).

In some embodiments, the location identifier 124 can determine a location is a point of compromise based on the ratio for the location. For example, the location identifier 124 can compare a ratio for the location to a threshold (e.g., a ratio threshold). Responsive to determining the ratio for the location exceeds the threshold, the location identifier 124 can determine the location is a point of compromise. The location identifier 124 can similarly compare ratios for locations to a threshold for any number of locations to determine whether the locations are points of compromise.

In some embodiments, the location identifier 124 can select the threshold to use depending on the location. For example, the location identifier 124 can store one or more (e.g., one or a plurality) of thresholds. Each threshold can correspond to a different set of locations. For each location, the location identifier 124 can identify the threshold that corresponds to the location in memory. The location identifier 124 can select or retrieve the threshold and compare the ratio for the location to the selected or retrieved threshold to determine whether the location is a point of compromise.

The stored thresholds can correspond to benchmarks for the individual locations. A benchmark can be a number of transactions or transaction cards that performed transactions at a location for a single time window or multiple time windows. The location identifier 124 can calculate or determine a benchmark for each location based on the data in the data structure. The location identifier 124 can then divide or group the different locations into different groups based on the benchmarks. An example table indicating division based on benchmarks is below:

| Set | benchmark | Ratio Threshold (%) |
|---|---|---|
| Set 1 | >=2500 | >=2 |
| Set 2 | >=250 | >=2.5 |
| Set 3 | >=25 | >=12 |
| Set 4 | >=10 | >=50 |

As illustrated, locations in sets with lower benchmarks can correspond with higher thresholds. Such can be the case, for example, to leave room for error for locations with a smaller sample size of transactions. The location identifier 124 can compare ratios that the location identifier 124 determined for each location to the threshold for the location to determine which of the locations may correspond to or be a point of compromise. The location identifier 124 can generate a table or dataframe that includes identifications of and/or the data (e.g., the transaction data) for the locations that the location identifier 124 determined may be or correspond to a point of compromise.

In cases in which the location identifier 124 determines benchmarks based on transactions in multiple time windows, the location identifier 124 may use a normalization technique to determine benchmarks for locations at which transactions were not performed within each of the multiple time windows. For example, the location identifier 124 may determine benchmarks for locations based on data of four different time windows (e.g., one week time windows). The location identifier 124 can identify a location in which transactions were only performed during time windows three and four with time windows one and two missing. In another example, the location identifier 124 can identify a location in which transactions were only performed in time windows one, two, and four with week three missing. The location identifier 124 can determine benchmarks for such locations using the following formula:

benchmark=benchmark*(total number of time windows/number of time windows in which transactions were performed)

In some cases, the total number of (e.g., a size of) time windows can be replaced with a defined value (e.g., a scale factor). The location identifier 124 can determine the ratio for such locations using the following formula:

ratio=compromised card count/benchmark

The compromised card count can be the number of rows for the location that include indications of fraudulent transactions. The location identifier 124 can use the determined location to determine which threshold to use for the location and to determine the ratio for the location to compare with the threshold.

The location identifier 124 can determine ratios for locations for multiple time windows (e.g., time windows of a time period). For example, the structure generator 122 can generate data structures for transactions that occur in different time windows (e.g., every day, week, two weeks, four weeks, month, two months, year, two years, etc.) of a time period (e.g., a set number of sequential time windows). The structure generator 122 can update the data structures to indicate transactions that correspond to subsequent fraudulent transactions by the same card only if the fraudulent transactions occur within the same time window or regardless of when the fraudulent transaction occurred. The location identifier 124 can determine benchmarks and/or thresholds for each location for each time window based on the transactions performed at the location during the time window or only determine the benchmark and/or threshold from a defined time window (e.g., the first time window of the time period) and defined number of time windows. The location identifier 124 can determine a ratio for each location for each time window by comparing the count of the number of rows for the location of the time window with indications of fraudulent transactions to the total count of rows for the location of the time window or to a benchmark the location identifier 124 calculated based on previous time windows. The location identifier 124 can compare ratios for the locations to the thresholds for the locations (e.g., the thresholds that correspond to the same time window or the thresholds that correspond to the defined time window). The location identifier 124 can identify locations that correspond to at least one ratio that exceeds the threshold for the location based on the comparisons.

The location identifier 124 can update the benchmarks for locations that initially did not correspond to transactions in enough time windows of the defined number of time windows. For example, the location identifier 124 may determine benchmarks for locations based on four time windows. A location may only correspond to transactions in two of the four time windows. The location identifier 124 may monitor transactions performed at the location and detect one or more transactions in three subsequent time windows. The location identifier 124 can use the transactions performed in the initial two subsequent time windows and in the initial two of four time windows to calculate the benchmark for the location without using any normalization techniques. The location identifier 124 can use the updated benchmark to determine the threshold and/or ratio for future time windows for the location. The location identifier 124 can similarly determine and/or update ratios and/or thresholds for any number of locations.

The location identifier 124 can generate a new or second data structure based on the locations the location identifier 124 determined correspond to at least one time window with a ratio exceeding a threshold. The second data structure can be a table (e.g., an SQL table) or a dataframe (e.g., a Python/R dataframe). The location identifier 124 can retrieve the transaction data of the locations the location identifier 124 identified and generate the second data structure by inserting the transaction data into rows of the second data structure similar to the initial data structure the structure generator 122 generated. Each row of the second data structure can correspond to a transaction and include the same data as the row of the initial data structure that corresponds to the same transaction. The location identifier 124 can process the second data structure to identify or detect points of compromise. Because the second data structure can contain fewer rows, such processing can reduce the query time of the processing, thus conserving computer resources compared to performing the processing techniques using the initial data structure with rows for each location.

The location identifier 124 can further filter locations that the location identifier 124 determined have ratios that exceed a threshold. The location identifier 24 can do so for each location based on the counts of transactions at the location that correspond to subsequent fraudulent transactions by the same transaction card. For example, for a location of the second data structure, the location identifier 124 can identify the rows that contain an indication of a fraudulent transaction. The location identifier 124 can determine a count of such rows for the location for each time window, thus generating multiple counts for the location. The location identifier 124 can identify a defined number (e.g., two) of counts of the earliest time windows. The location identifier 124 can use the counts to determine a threshold (e.g., a compromise threshold).

The location identifier 124 can use one or more functions on the identified counts to determine the threshold for the location. For example, the location identifier 124 can calculate or determine an average of the identified counts. The average can be the threshold. In another example, the location identifier 124 can determine the average and the standard deviation of the identified counts. The location identifier 124 can determine the threshold as a sum of the average and the standard deviation. In some cases, the location identifier 124 can adjust the standard deviation based on a predetermined value. The predetermined value can be the same value for every location or can differ based on the number of transactions that are performed at the location (e.g., different predetermined values can correspond to different sets of locations similar to the thresholds as described above, where locations in which more transaction occur can correspond to lower values (e.g., 2) than values of other locations (e.g., 2.5, 3, etc.)). Accordingly, the location identifier 124 can determine or calculate the location according to the equation:

threshold=compromised card count average+N*standard deviation

where N is the predetermined value for the location. The location identifier 124 can similarly determine thresholds for any number of locations.

The location identifier 124 can determine whether the count of rows that contain indicators of fraudulent transactions for a time window subsequent to the defined number of time windows exceeds the threshold. For example, the location identifier 124 can determine a threshold for a location based on transactions that were performed in a first time window and a second time window subsequent the first time window. The location identifier 124 can determine a count of rows that contain indicators of fraudulent transactions for a third time window subsequent the second time window. The location identifier 124 can determine and compare the count of rows of the third time window with the threshold. Responsive to determining the count exceeds the threshold, the location identifier 124 can mark or label (e.g., store an indication of a compromised time window in memory) the time window as corresponding to a compromised time window for the location. Otherwise, the location identifier 124 can mark or label the time window as not corresponding to a compromised time window. The location identifier 124 can similarly determine compromised time windows for any number of locations.

The location identifier 124 can determine compromised time windows by calculating a rolling threshold for the location. The location identifier 124 can update the threshold based on the transaction data of the time windows subsequent to the defined number of time windows. For example, subsequent to determining the third time window is compromised for a location, the location identifier 124 can recalculate the threshold for the location as described above using the counts of the first, second, and third time windows. The location identifier 124 can determine and compare the count of rows that correspond with fraudulent transactions for the location within the fourth time window with the updated or recalculated threshold. The location identifier 124 can mark or label the fourth time window accordingly. The location identifier 124 can similarly update or recalculate thresholds and determine whether the time windows correspond with compromised time windows for any number of time windows for a location. The location identifier 124 can determine compromised time windows for any number of locations.

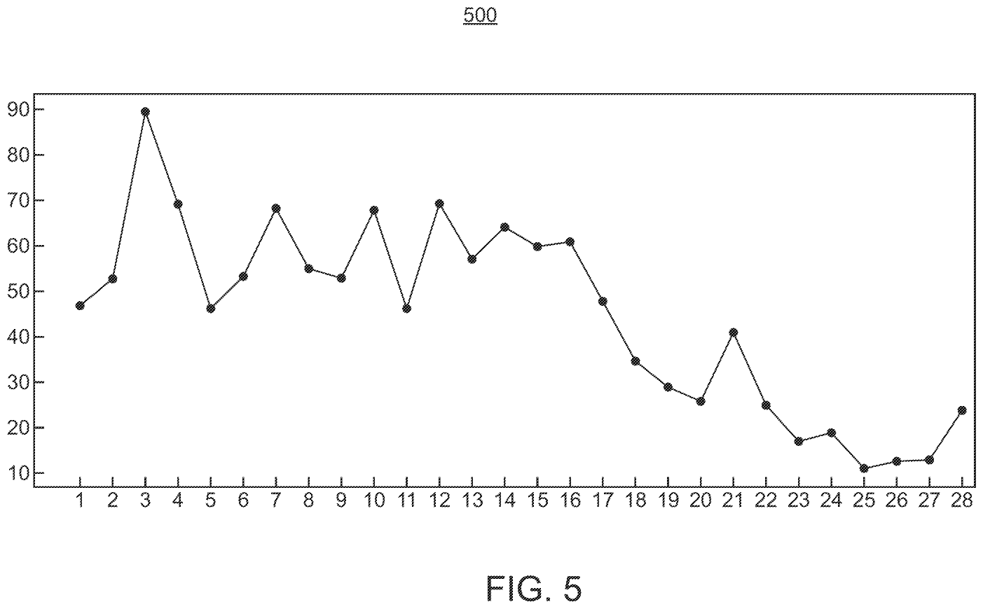

In some embodiments, the location identifier 124 may not update or recalculate a threshold for a location for a time window responsive to determining the time window is an outlier or is compromised (e.g., has a count of rows that correspond with fraudulent transactions that exceed the threshold for the time window). For example, the count of rows with indications of fraudulent transactions at a third time window can be compared with a threshold determined or calculated based on transactions that occurred in a first time window and a second time window prior to the third time window. The location identifier 124 can determine the third time window is an outlier responsive to determining the count exceeds the threshold. Accordingly, the location identifier 124 can determine and compare the count of rows that correspond with fraudulent transactions for a fourth time window subsequent to the third time window to the same threshold generated based on transactions of the first time window and the second time window. The location identifier 124 can determine the fourth time window is an outlier responsive to determining the count for the fourth time window exceeds the threshold. Accordingly, the location identifier 124 can determine and compare the count of rows that correspond with fraudulent transactions for a fifth time window subsequent to the fourth time window to the same threshold generated based on transactions of the first time window and the second time window. The location identifier 124 can determine the fifth time window is not an outlier. Accordingly, the location identifier 124 can determine and compare the count of rows that correspond with fraudulent transactions for a sixth time window subsequent to the fifth time window to a threshold the location identifier 124 based on rows of transactions that occurred during the first time window, the second time window, and the fifth time window. The location identifier 124 can similarly update the threshold and determine whether time windows are compromised for any number of time windows. In some cases, the location identifier 124 may only use a defined number of the most recent time windows (e.g., the most recent non-outlier time windows) to determine thresholds to account for any changes in operation over time. The location identifier 124 can similarly determine compromised time windows for any number of locations (e.g., only locations of the second data structure). An example graph depicting counts of rows that correspond with fraudulent transactions at a location over multiple time windows is illustrated in FIG. 5 as a graph 500.

The location identifier 124 can maintain and increment a counter for each location. The location identifier 124 can increment the counter for a location responsive to determining transactions in a time window correspond to a compromised time window as described above. The counts can be frequencies at which the locations corresponded with compromised time windows over the course of a time period (e.g., a time period including each time window for which the location identifier 124 monitored the location).

The location identifier 124 can generate a new data structure or a third data structure based on the locations from the second data structure that the location identifier 124 determined correspond to at least one compromised time window. The third data structure can be a table (e.g., an SQL table) or a dataframe (e.g., a Python/R dataframe). The location identifier 124 can retrieve the transaction data of the locations the location identifier 124 identified. The location identifier 124 can generate the third data structure by inserting the retrieved transaction data into rows of the third data structure similar to the initial data structure the structure generator 122 generated and/or the second data structure the location identifier 124 generated. Each row of the third data structure can correspond to a transaction and include the same data as the row of the initial data structure or the second data structure that corresponds to the same transaction. The location identifier 124 can process the third data structure to identify or detect points of compromise. Because the third data structure contains fewer rows, such processing can reduce the query time of the processing, thus conserving computer resources compared to performing the processing techniques using the initial or second data structure with rows for each location.

The location identifier 124 can generate a new data structure or a fourth data structure based on the locations from the third data structure for which the location identifier 124 determined to have a count or frequency of compromised time windows exceeding one or another defined value. The third data structure can be a table (e.g., an SQL table) or a dataframe (e.g., a Python/R dataframe). For example, the location identifier 124 can compare counts of the counters maintained by the location identifier 124 that indicate the number of compromised time windows for the individual locations. The location identifier 124 can compare the counts to the defined value. The location identifier 124 can identify the locations that correspond to counts that exceed the defined value. The location identifier 124 can retrieve the transaction data of the locations the location identifier 124 identified with counts that exceed the defined value and generate the fourth data structure by inserting the transaction data into rows of the fourth data structure similar to the initial data structure the structure generator 122 generated and/or the second or third data structure the location identifier 124 generated. Each row of the fourth data structure can correspond to a transaction and include the same data as the row of the initial data structure or the second or third data structure that corresponds to the same transaction. The location identifier 124 can process the fourth data structure to identify or detect points of compromise. Because the fourth data structure contains fewer rows, such processing can reduce the query time of the processing, thus conserving computer resources compared to performing the processing techniques using the initial, second or third data structure with rows for each location.

The location identifier 124 can identify the locations that correspond with the highest counts or frequencies. For example, the location identifier 124 can compare the counts or frequencies of compromised time windows between the different locations. Based on the comparison, the location identifier 124 can determine or identify a defined number of locations that correspond with the highest counts or frequencies. The defined number can be any number. The table below illustrates an example table identifying the locations that correspond with the top two frequencies of compromised time windows at time window six.

| Location | Frequency |
|---|---|
| merchant_b | 2 |
| merchant_e | 2 |

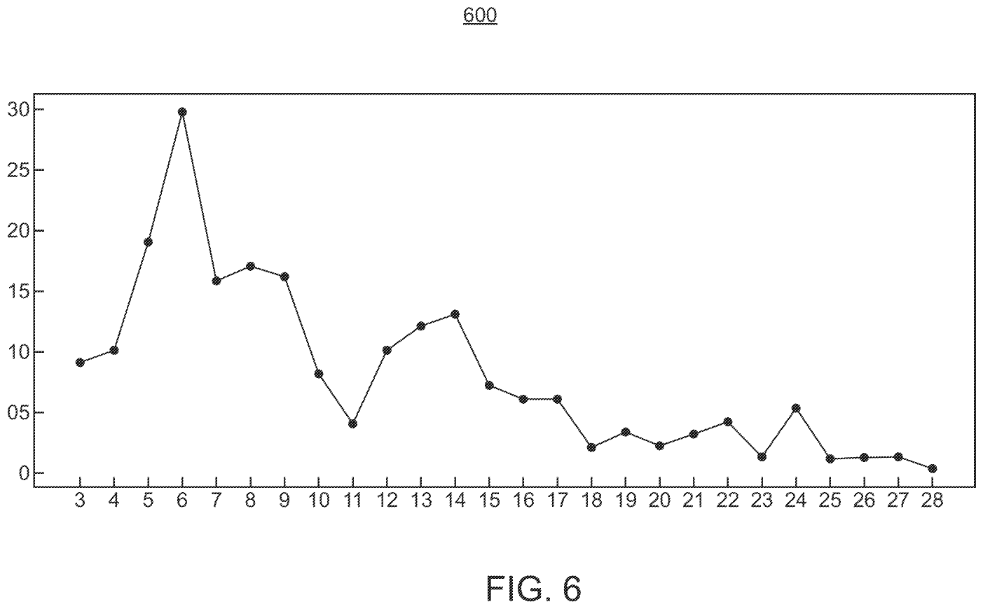

The graph 500 of FIG. 5 depicts the trend plot of the location merchant_b in the table including normal behaviors and outliers over 28 time windows. As illustrated in the graph 500, the count of compromised transactions or cards climbed at time window three and four but dropped down to an initial level at time windows five and six. A graph 600 illustrated in FIG. 6 depicts an example trend plot of the other location merchant_c.

The location identifier 124 can generate a new or fifth data structure based on the locations the location identifier 124 determined to have the highest frequencies. The fifth data structure can be a table (e.g., an SQL table) or a dataframe (e.g., a Python/R dataframe). The location identifier 124 can retrieve the transaction data of the locations the location identifier 124 identified and generate the fifth data structure by inserting the transaction data into rows of the fifth data structure similar to the initial data structure the structure generator 122 generated or the other data structures generated by the location identifier 124. Each row of the fifth data structure can correspond to a transaction and include the same data as the row of the initial data structure or other prior data structures that corresponds to the same transaction. The location identifier 124 can process the fifth data structure to identify or detect points of compromise. In some cases, the locations for which transaction data are included in the fifth data structure can be points of compromise. Because the fifth data structure contains fewer rows, such processing can reduce the query time of the processing, thus conserving computer resources compared to performing the processing techniques using the initial, second, third, or fourth data structure with rows for each location.

The location identifier 124 can identify points of compromise from data of the fifth data structure. The location identifier 124 can do so by applying one or more rules to the data of the fifth data structure. For example, the location identifier 124 can store one or more rules that correspond to patterns or sequences (e.g., defined number of outliers or compromised time windows in a row or an increase in counts between one or more time windows that exceeds a threshold). If a pattern or sequence is satisfied or matched by the transaction data of a location, the location identifier 124 can determine the location is a point of compromise. In another example, the location identifier 124 can generate a graphical or visual representation of the data (e.g., counts of rows with fraudulent transactions) for individual time windows. The location identifier 124 can transmit (e.g., via the communicator 120) the graphical representations to a computing device (e.g., the remote computing device 112). The computing device can display the graphical or visual representation on a display. In some cases, the location identifier 124 can additionally or instead transmit and the computing device can display the raw data of transactions performed at the location. A reviewer can review the graphical or visual representations of the data and/or the raw data and determine whether the location is a point of compromise. The reviewer can review such data for each location that the location identifier 124 included in the fifth data structure. The reviewer can provide one or more inputs via an input/output device into the computing device that indicate whether the locations are points of compromise or not. The computing device can transmit identifications of the input back to the compromise detection system 108. The location identifier 124 can label or mark an indication of whether the locations are points of compromise or not based on the reviewer input or the location identifier 124's determinations. Thus, the location identifier 124 can determine and store indications of points of compromise using tables or dataframes.

The record generator 126 may comprise programmable instructions that, upon execution, cause the processor 116 to generate a record (e.g., a file, document, table, listing, message, notification, etc.). The record generator 126 may generate the record to include a list of locations that the location identifier 124 identified as corresponding to or being a point of compromise. The record generator 126 can generate the record to include a list based on any of the second-fifth data structures or locations selected from the fifth data structure described above, depending on the embodiment. The record can include a stored association between identifications of the locations on the list and an identification indicating a point of compromise. For example, the record generator 126 may include an identification for each location of the fifth data structure that the location identifier 124 marked or labeled as corresponding to or being a point of compromise. In some cases, the record generator 126 may include the transaction data for the locations in the record (e.g., the transaction data that the location identifier 124 used to determine the locations are points of compromise). In one example, the record may be or include a spreadsheet or table that includes identifications of locations determined to be points of comprise as well as the rows of the locations in the fifth data structure.

The record generator 126 can transmit the record to a computing device (e.g., the remote computing device 112). In some cases, the record generator 126 can transmit the record to a computing device that transmitted a request for the record generator 126 to detect or determine points of compromise. The computing device can receive the record and display the record on a user interface.

In some embodiments, the fifth data structure can be dynamic and change over time. For example, as the compromise detection system 108 receives transaction data for different locations, the structure generator 122 can update the data structure and the location identifier 124 can identify and/or remove locations as being possibilities for being points of compromise. For instance, the location identifier 124 can increase or decrease the rankings of individual locations based on the frequencies with which the location identifier 124 has determined the locations correspond with compromised time windows. In some cases, the location identifier 124 can remove locations from the list upon determining the locations are points of compromise based on data of previous time windows such that the location identifier 124 can identify other or new points of compromise. An example of an updated table is below.

| Location | Frequency |
|---|---|
| merchant_e | 5 |
| merchant_b | 4 |
| merchant_f | 3 |
| merchant_g | 2 |
| merchant_h | 2 |

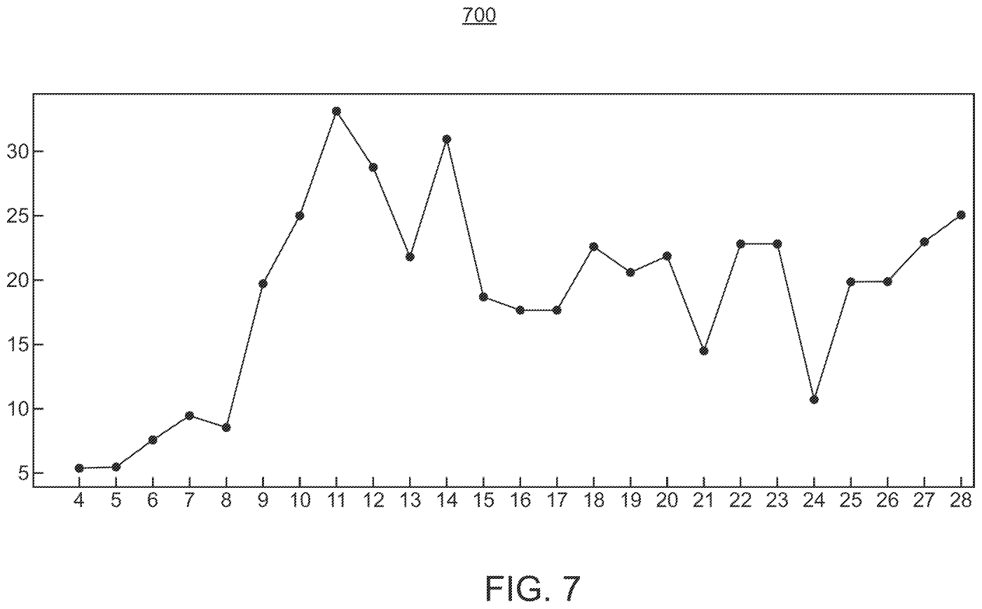

FIG. 7 illustrates a graph 700 which depicts the trend plot of the location merchant_f in the table from time windows 4 to 28. As illustrated in the graph 700, merchant_f had three outliers at time windows 7, 9, and 10. Starting from time window 9, the compromised card count increased and kept the increasing trend for a few consecutive windows. The outliers visually formed an outlier plateau.

As illustrated in the graphs 500, 600, and 700, points of compromise can differ between different locations. In the graphs 500 and 600, the compromised card count formed an outlier spike. Then the count dropped and formed a valley to the right which was around the same level of previous performance. If the compromised card count dropped quickly, it could mean that the volume of compromised cards shrank instantly, and that the location is no longer a point of compromise or the risk associated with the point of compromise has been reduced. The graph 700 depicts a different pattern. For instance, from windows 9 to 23 of the graph 700, the compromised card count formed a steady outlier plateau. This would mean that the compromised card exposure lasted significantly longer. The steady increase may indicate a maintained point of compromise and an increased or maintained risk associated with the point of compromise.

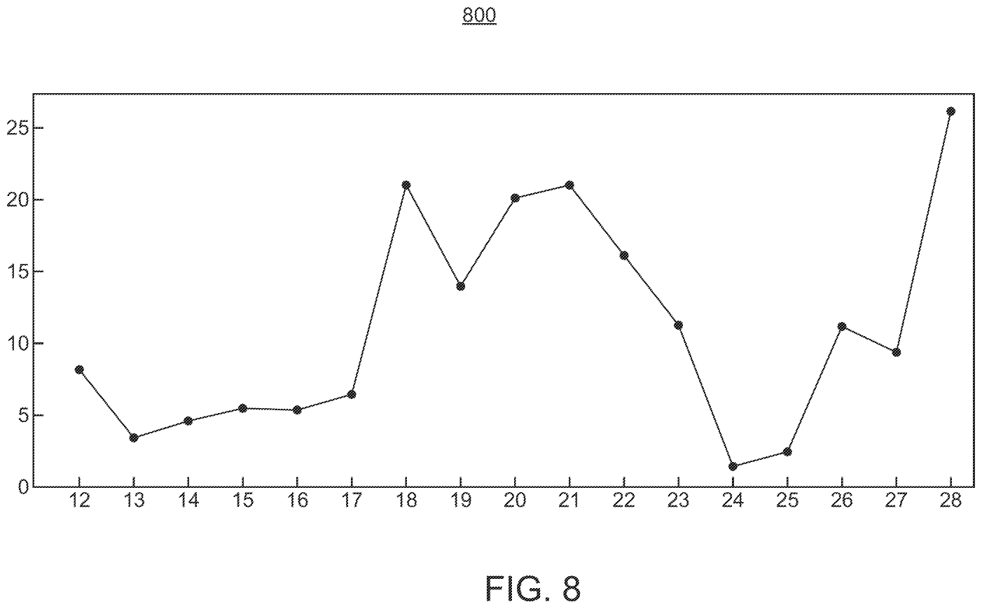

An outlier plateau is not uncommon for the point of compromise candidates. For example, FIG. 8 illustrates a graph 800 that includes a trend plot of a point of compromise location. The graph 800 illustrates that the compromise detection system 108 began collecting data for the location at time window 12. Between time windows 18 and 23, the compromised card count formed an outlier plateau. If remediation is taken during this time period, the depicted increase at a time window 28 may have been avoided.

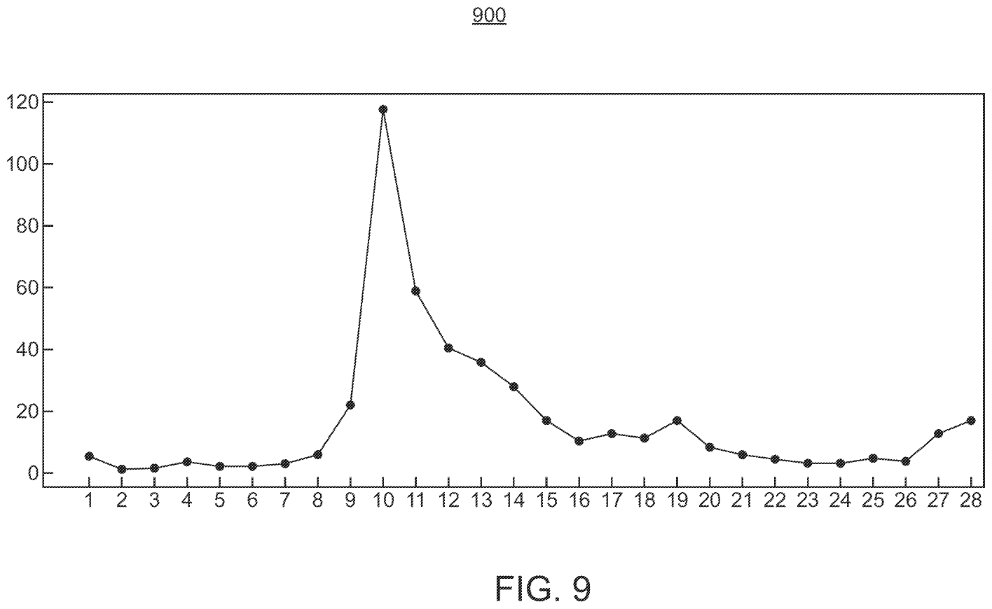

Besides outlier plateaus, there are some other graphical patterns that might be related to the point of compromise events. For example, a graph 900 illustrated in FIG. 9 depicts the trend plot of a location. The location qualified under phase one filtering starting at time window 1 but didn't qualify under phase two filtering until window 9. Then the location had a consecutive outlier at time window 10 and was selected during the phase three filtering. At the phase four filtering, the location's entire performance starting from window 1 to current was analyzed by the location identifier 124 and/or a human reviewer. The compromised card count jumped at time window 9, and further reached a spike at time window 10. Then the compromised card count started to drop with a slow slope to the right, and the slope was well above the threshold. This location could be classified as a final POC candidate.

At the phase four filtering, the location identifier 124 and/or a human reviewer can analyze the trend plot of the top candidates selected at phase three including their normal behaviors and outliers. If the compromised card count of each top candidate dropped quickly after the outlier spikes, the locations can be kept in the top list for next time evaluation. The location identifier 124 or reviewer can select locations if there is an apparent outlier plateau or an outlier spike with a slow slope at the locations. The record generator 126 can generate a record comprising a list of the selected locations.

In this way, an unsupervised learning method with four-phase filtering can be used to detect points of compromise. Because fraudulent transactions are usually later than the compromise events, the compromise detection system 108 can use new fraudulent transactions to trace back their previous transactions and associated locations. With four-phase filtering, the most likely points of compromise can emerge. Data handling and measure feature computations can be implemented and updated with SQL tables or Python/R dataframes. The compromise detection system 108 or a human reviewer can use a visualization tool to detect or identify points of compromise.

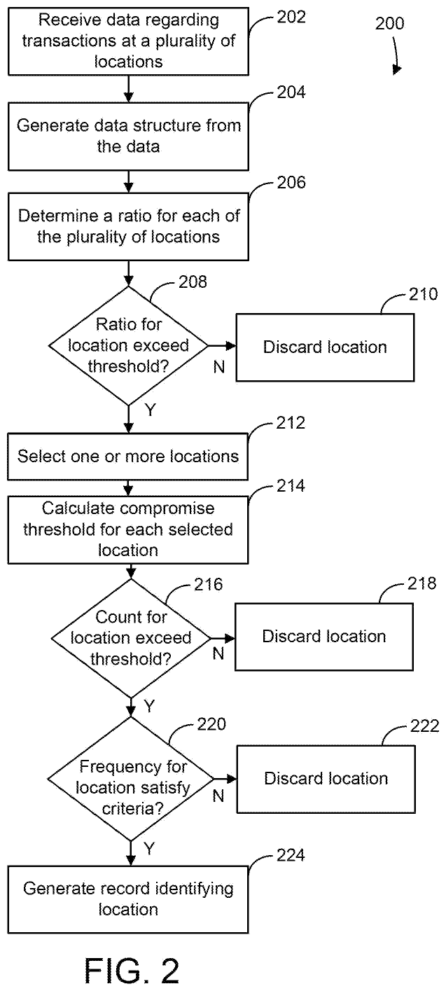

FIG. 2 is an illustration of an example method 200 for detecting points of compromise, in accordance with an implementation. The method 200 can be performed by a data processing system (e.g., a client device or the compromise detection system 108, shown and described with reference to FIG. 1, a server system, etc.). The method 200 may include more or fewer operations and the operations may be performed in any order. Performance of the method 200 may enable the data processing system to efficiently detect points of compromise using a non-matrix-based algorithm. The method 200 instead enables the data processing system to detect points of compromise using table or dataframe data structures. Using such data structures can enable the data processing system to detect points of compromise more efficiently than processing a large number of rows and columns that can be associated with detecting points of compromise using matrices.

In the method 200, at operation 202, the data processing system receives data regarding transactions at a plurality of locations. The data processing system can receive the data from computing devices associated with different locations. The data can be transaction data for individual transactions performed at the locations. The data can include attributes of the individual transactions, such as identifications of cards (e.g., transaction cards) that performed the transactions, identifications of the locations of the transactions, the amounts or values of the transactions, the date and/or time in which the transactions occurred, etc. The data processing system can receive the data from point-of-sale devices located at the individual locations or from computers that receive the data from such point-of-sale devices. The locations can be individual merchants or other locations that correspond with one or more point-of-sale devices. In some cases, locations can include online merchants and correspond to the online entity associated with the merchants.

At operation 204, the data processing system generates a data structure (e.g., an initial data structure) from the received data. The data structure can be a table (e.g., an SQL table) or a dataframe (e.g., a Python/R dataframe). The data structure can include multiple rows and multiple columns. The data processing system can generate the data structure from the data by identifying data for individual transactions and inserting the data into different rows such that each row corresponds to a different transaction. The data processing system can generate the data structure such that each row corresponds to a different transaction and includes an identification of the location at which the transaction occurred, an identification of the card that performed the transaction, and a date of the transaction. The data processing system can insert indications of fraudulent transactions into rows for transactions when the cards that were used to perform the transactions of the rows are later used to perform a fraudulent transaction. The indications can be values (e.g., numeric or alphanumeric values) or dates of the fraudulent transactions.

At operation 206, the data processing system determines a ratio for each of the locations. The data processing system can determine a ratio for each location that corresponds to an identification in the data structure. The ratio for a location can be a ratio of rows in the data structure that contain an identification of the location and an indication of a fraudulent transaction to a total number of rows that contain the identification of the location. The data processing system can determine such a ratio by querying the data structure and identifying such rows. The data processing system can compare the counts of the two types of rows together to determine the ratio for the location. The data processing system can determine such ratios for any number of locations.

At operation 208, the data processing system determines whether a ratio for a location exceeds a threshold. The data processing system can determine whether the ratio for the location exceeds the threshold by comparing the ratio to the threshold. Responsive to determining the ratio does not exceed the threshold, the data processing system may determine the location is not a point of compromise. Responsive to either such determination, at operation 210, the data processing system can discard the location (e.g., remove an identification of the location from memory or otherwise stop processing transaction data in rows that contain an identification of the location). The data processing system can similarly calculate ratios and determine whether the ratios exceed the threshold for any number of locations.

At operation 212, the data processing system selects one or more locations. The data processing system can select the one or more locations responsive to determining each of the one or more locations has a ratio that exceeds a threshold at the operation 208, for example. The data processing system can select the one or more locations by generating a new or second data structure. The data processing system can generate the second data structure using the same or similar data to the initial data structure. The data processing system can generate the second data structure such that each of the rows of the second data structure correspond to or match the rows of the initial data structure that contain identifications of the locations the data processing system selected based on the ratios of the selected locations.

At operation 214, the data processing system calculates a threshold (e.g., a compromise threshold) for each selected location. The data processing system can calculate the threshold for a location based on counts of rows that correspond with fraudulent transactions for individual time windows. For example, the data processing system can collect transaction data of transactions that are performed for a time period. The data processing system can store identifications of different or multiple time windows within the time period. The data processing system can identify rows that contain dates with first and second time windows within the time period and an identification of the location. From the identified rows, the data processing system can identify rows that include indications of fraudulent transactions subsequent to the transactions of the rows. The data processing system can maintain and increment a counter for each of the first and second time windows. The data processing system can calculate the threshold for the location based on the counts of the counters (e.g., calculate an average of the counts, a standard deviation of the counts, aggregate such an average and standard deviation together, aggregate such an average and a standard deviation multiplied by a defined or predetermined value, etc.). The data processing system can similarly calculate thresholds for each location of the second data structure.

At operation 216, the data processing system determines whether a count for a location exceeds a threshold. The threshold can be the threshold the data processing system calculated for the location based on the counts of rows in the second data structure that correspond with fraudulent transactions. The count can be a count of rows in the second data structure that correspond with fraudulent transactions and a transaction date within a third time window subsequent to the first and second time windows. The data processing system can compare the count to the threshold. Responsive to determining the count does not exceed the threshold, at operation 218, the data processing system can discard the location. Otherwise, the data processing system can mark or label the third time window as an outlier or a compromised time window. The data processing system can similarly calculate counts and determine whether the counts exceed thresholds for any number of locations.

The data processing system can determine outliers or compromised time windows for any number of time windows for a location. In doing so, the data processing system can calculate or update thresholds to use for each time window. For example, the data processing system can calculate or determine a threshold for the location for a fourth time window. To do so, the data processing system can identify the counts of rows that correspond with fraudulent transactions in each of the first, second, and third time windows. The data processing system can use the same function or functions that the data processing system used to calculate the threshold for the third time window on the counts of the first, second, and third time windows to calculate the threshold for the fourth time window. The data processing system can then determine a count of rows that correspond with fraudulent transactions for the fourth time window and compare the count to the threshold the data processing system calculated for the fourth time window. The data processing system can mark or label the fourth time window as compromised or an outlier responsive to determining the count for the fourth time window exceeds the threshold for the fourth time window. The data processing system can determine whether any number of time windows are compromised for a location. In some cases, the data processing system may not calculate a new threshold for a time window upon determining the immediately preceding tine window is a compromised time window. In such cases, the data processing system may instead use the last threshold the data processing system calculated (e.g., the threshold the data processing system calculated based on data of non-compromised time window). The data processing system can similarly calculate compromised time windows for any number of locations of the second data structure.

The data processing system can maintain and increment a counter for each location (e.g., each location that corresponds to at least one compromised time window). For each location, the data processing system can increment the counter for the location for each time window that the data processing system determined to be compromised. The count of the counter can be a frequency of compromised time windows for the location.

At operation 220, the data processing system can determine whether a frequency of compromised time windows for a location satisfies any criteria. The criteria can be or include one or more rules. Examples of rules include, but are not limited to, the frequency of a location satisfies a threshold (e.g., a defined value) or the frequency is one of a defined number of highest frequencies that the data processing system calculated based on the collected or received data. The data processing system can compare the frequency for the location to the criteria to determine if any criteria are satisfied (e.g., compare the frequency to a threshold to determine if the frequency exceeds the threshold or compare the frequencies of the locations between each other to identify the defined number of highest frequencies). Responsive to determining the frequency for a location does not satisfy any criteria, at operation 222, the data processing system can discard the location. The data processing system can identify any locations that satisfy a criterion based on the comparison as a point of compromise.

At operation 224, the data processing system generates a record identifying a location. The data processing system can generate the record by inserting identifications of the locations the data processing system identified as being points of compromise into the record. The data processing system can store the identifications of the locations with associations with an identification of a point of compromise (e.g., a string indicating a point of compromise) in the record. The data processing system can transmit the record in one or more data packets to a remote computing device. In some cases, the data processing system can transmit the record to a remote computing device that requested a list of points of compromise. In some embodiments, the data processing system can perform the method 200 at set intervals and transmit the record to a remote computing device at the end of each interval to monitor the different locations for malicious activity.

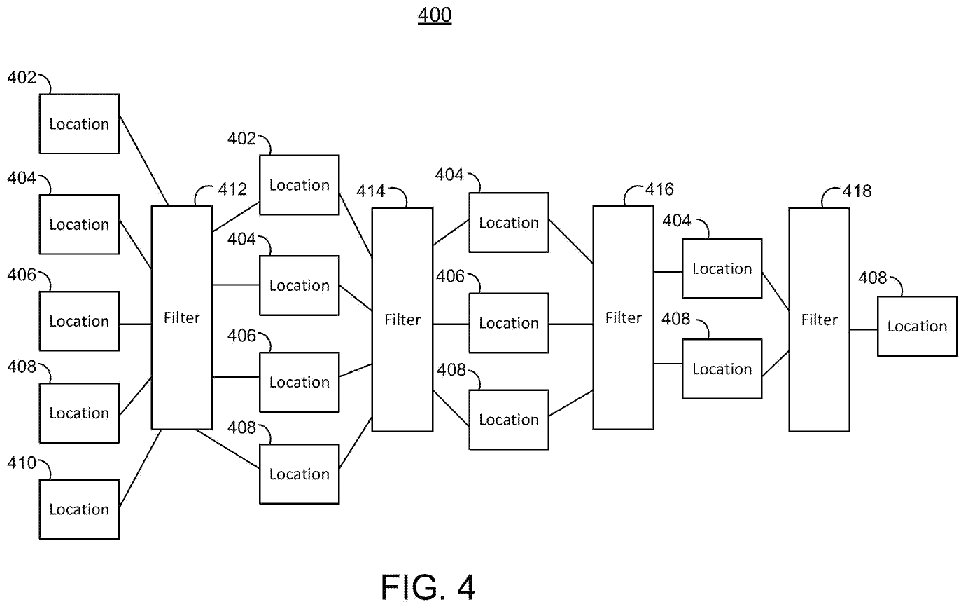

Referring now to FIG. 4, an example sequence 400 for filtering locations to detect points of compromise is shown, in accordance with an implementation. The sequence 400 can be performed by a data processing system (e.g., a client device or the compromise detection system 108, shown and described with reference to FIG. 1, a server system, etc.). The sequence 400 may include more or fewer operations and the operations may be performed in any order. Performance of the sequence 400 may enable the data processing system to efficiently detect points of compromise using a non-matrix-based algorithm. The sequence 400 can instead enable the data processing system to detect points of compromise using table or dataframe data structures.

In the sequence 400, the data processing system can collect or receive data (e.g., transaction data) regarding locations 402, 404, 406, 408, and 410. The data processing system can generate a first data structure from the transaction data by placing data for individual transactions of the data into different rows of the first data structure. The first data structure can be a table or dataframe to enable the processing and the data processing system to perform the processing using fewer resources (e.g., using one dimensional processing as opposed to two-dimensional three-dimensional processing as in matrix processing).

The data processing system can apply a first filter 412 to the data in the first data structure. The first filter 412 can be or include executable instructions that reduce the number of locations that could be points of compromise (e.g., potential points of compromise). The data processing system can apply or execute the first filter 412 to calculate ratios for each of the locations 402-410. The ratios can indicate the number of transactions that were performed at the location by cards that later performed a fraudulent transaction. The data processing system can determine such a ratio for each location and compare the ratio for each location to a threshold. Based on the comparison, the data processing system can identify the locations 402, 404, 406, and 408 as locations with ratios that exceeded a threshold and are potential points of compromise. The data processing system can remove the location 410 as a possibility. The data processing system can generate a second data structure similar to the first data structure with the transaction data for the locations 402, 404, 406, and 408 (e.g., but not the location 410).

The data processing system can apply a second filter 414 to the data in the second data structure. The second filter 414 can be or include executable instructions that reduce the number of locations that could be points of compromise. The data processing system can apply or execute the second filter 414 to calculate thresholds for each of the locations 402-408. The data processing system can calculate a threshold for each of the locations 402-408 based on a count of transactions that were performed at each location prior to a fraudulent transaction over different time windows. The data processing system can perform a function (e.g., an average, a standard deviation, a sum of an average or standard deviation, etc.) on the counts between the different time windows to determine thresholds for the locations 402-408. The data processing system can determine a count of transactions that were performed at each location in a time window subsequent the time windows the data processing system used to calculate the thresholds. The data processing system can compare the counts to the thresholds for the locations 402-408. The data processing system can identify the locations that correspond to at least one time window with a count that exceeds a threshold as potential points of compromise. Accordingly, the data processing system can identify the locations 404, 406, and 408. The data processing system can discard the location 402 and remove the location 402 as a possibility for being a point of compromise. The data processing system can generate a third data structure similar to the first and second data structures with the transaction data for the locations 404, 406, and 408 (e.g., but not the location 410 or the location 402).

The data processing system can apply a third filter 416 to the data in the third data structure. The third filter 416 can be or include executable instructions that reduce the number of locations that could be points of compromise. The data processing system can apply or execute the third filter 416 to calculate frequencies of outlier or compromised time windows for each of the locations 404-408. The data processing system can determine the frequencies by periodically updating or recalculating thresholds for each time window of transactions for the locations 404-408 and/or comparing counts for the different time windows to such thresholds. For example, the data processing system can determine a threshold for the location 404 based on transaction data of a first time window and a second time window. The data processing system can determine and compare a count of rows that correspond with fraudulent transactions for a third time window to the threshold and determine the third time window is an outlier or is compromised responsive to determining the count is higher than the threshold. The data processing system can then determine and compare a count of a fourth time window to the same threshold. The data processing system can use the same threshold instead of recalculating or updating the threshold based on transaction data of the third time window because the data processing system determined the third time window to be an outlier or compromised. The data processing system can determine the fourth time window is not compromised or an outlier responsive to determining the count for the fourth time window is below the threshold. The data processing system can calculate a threshold based on transaction data of the first time window, the second time window, and the fourth time window. The data processing system can determine and compare a count of rows that correspond with fraudulent transactions for the location to the threshold. The data processing system can increment a counter for each time window that the data processing system determines is compromised for the location. The data processing system can repeat the process for any number of time windows for a location. The data processing system can repeat the process for any number of locations. The counts of the counters can be frequencies.

The data processing system can compare the frequencies to one or more criteria. The criteria can be or include, for example, a threshold and a rule to identify a defined number of locations with the highest frequencies (e.g., the highest frequencies of the calculated frequencies). The data processing system can compare the frequencies for the locations to the criteria. Based on the comparison, the data processing system can identify the frequencies that satisfy at least one criterion. In doing so, the data processing system can identify the locations 404 and 408. The data processing system can generate a fourth data structure similar to the first, second, and third data structures with the transaction data for the locations 404 and 408 (e.g., but not the locations 402, 406, or 410).

The data processing system can apply a fourth filter 418 to the data in the fourth data structure. The fourth filter 418 can be or include executable instructions that reduce the number of locations that could be points of compromise. The data processing system can apply or execute the fourth filter 418 to apply one or more rules to data of each location of the fourth data structure (e.g., the locations 404 and 408). In one example, the data processing system can determine counts of rows that correspond with fraudulent transactions in different time windows for each location of the fourth data structure and determine which location satisfies a criterion based on the comparison. In another example, the data processing system can generate a graphical or other visual representation of such counts and transmit the generated representation to another computer. In some cases, the data processing system can transmit raw data for the locations to the computer instead of or in addition to the generated representations. A user accessing the computer can view the representations for each location and select an option indicating which of the locations is a point of compromise. The computer can send the selection for each location to the data processing system and the data processing system can identify the selections. The data processing system can identify the locations that satisfied the criteria (e.g., have a highest frequency, a frequency that exceeds as a threshold, or were selected as points of compromise) as points of compromise. In doing so, for example, the data processing system can identify the location 408. The data processing system can generate a record that includes an identification of the location 408 and an identification of a point of compromise. The data processing system can transmit the record to a remote computing device.

Depending on the embodiment, the data processing system can identify the points of compromise as the output of any of the filters 412, 414, 416, or 418. The data processing system can generate a record that includes the identifications of locations output by any of the filters 412, 414, 416, or 418 and transmit the record to a remote computing device. The remote computing device can display the record on a user interface to a user to illustrate the locations the data processing system identified as being points of compromise.

Using the different filters 412-418 to detect points of compromise can cause the data processing system to be more accurate. For example, only executing the filter 414 to filter out points of compromise may cause the data processing system to determine locations are points of compromise based on random noise. However, only executing the filter 412 can cause the data processing system to not be able to identify locations with abrupt changes over time compared with other locations. Thus, executing each of the filters 412-418 can enable the data processing system to use tables or dataframes to detect points of compromise efficiently and accurately.

At least one aspect of a technical solution to the problems described herein is directed to a system for maintaining data integrity. The system can include a network interface and a processor coupled to memory. The processor can be configured to receive, via the network interface and from one or more computing devices, data regarding a plurality of transactions performed at a plurality of locations; generate, from the data, a data structure, wherein the data structure comprises a plurality of rows, each row corresponding to a different transaction of the plurality of transactions and including an identification of a location, an identification of a card that performed the transaction at the location, and a date of the transaction at the location, and wherein a subset of the plurality of rows each comprise an indication of a fraudulent transaction subsequent to the date of the transaction of the row; for each of the plurality of locations, determine a ratio of a count of rows of the subset of rows for the location that each include a date of a fraudulent transaction to a count of rows of the plurality of rows for the location; determine a location from the plurality of locations is a point of compromise based on the ratio for the location; and generate a record comprising a stored association between an identification of the location and an identification indicating a point of compromise responsive to the determination.

In some embodiments, the data structure is a standard query language (SQL) table or a Python/R dataframe. In some embodiments, the processor is configured to determine the location is a point of compromise based on the ratio of the location by comparing the ratio of the location with a ratio threshold; and determining the location is a point of compromise responsive to the location exceeding the ratio threshold. In some embodiments, the processor is configured to store a plurality of ratio thresholds, each of the plurality of ratio thresholds corresponding to a different set of locations of the plurality of locations, wherein the processor is configured to compare the ratio of the location with the ratio threshold based on the ratio threshold corresponding to the location.

In some embodiments, the processor is configured to receive the data by receiving the data during a time period, and wherein the processor is configured to determine the location is a point of compromise based on the ratio for each of the plurality of locations by selecting one or more of the plurality of locations based on the ratios of the one or more locations exceeding a ratio threshold; for each of the selected one or more locations, calculate a compromise threshold based on rows of the data structure that each correspond to a transaction and contain the identification of the location, an indication of a fraudulent transaction subsequent to the transaction, and a date of the transaction within a first set of two or more time windows of the time period; and compare, to the compromise threshold and for each of one or more time windows of the time period subsequent to the first set of two or more time windows of the time period, a second count of rows of the data structure that each correspond to a transaction and contain the identification of the location, an indication of a fraudulent transaction subsequent to the transaction, and a date of the transaction within the time window of the one or more time windows, wherein the processor is configured to determine the location is a point of compromise responsive to determining the second count of rows for the location exceeds the compromise threshold for the location.

In some embodiments, the processor is configured to, for each of the selected one or more locations, determine a frequency of time windows based on a number of time windows in which the second count of rows of the time window for the location exceeds one or more compromise thresholds for the location; and identify a defined number of locations that correspond with the highest frequencies, the defined number of locations comprising the location.

In some embodiments, the processor is configured to calculate a second compromise threshold for a second location of the plurality of locations by calculating a first count of a number of rows of the data structure that each correspond to a transaction and contain the identification of the second location, an indication of a fraudulent transaction subsequent to the transaction, and a date of the transaction within a first time window of the plurality of time windows; calculating a second count of a number of rows of the data structure that each correspond to a transaction and contain the identification of the second location, an indication of a fraudulent transaction subsequent to the transaction, and a date of the transaction within a second time window of the plurality of time windows; and calculating an average of the first count and the second count. In some embodiments, the processor is configured to calculate the threshold by calculating a standard deviation based at least on the first count and the second count; and calculating the second compromise threshold based at least on the calculated average and standard deviation. In some embodiments, the processor is configured to calculate the second compromise threshold based further on a predetermined value.

In some embodiments, the processor is configured to receive the data by receiving the data during a time period comprising a plurality of time windows, and wherein the processor is configured to identify a second location of the plurality of locations with data for at least one transaction in a number of time windows of the time period fewer than a number of the plurality of time windows; and for the second location, determine the ratio of the count of rows of the subset of rows of the second location that include a date of a fraudulent transaction to a count of rows of the plurality of rows of the second location over a size of the number of time windows with data for at least one transaction. In some embodiments, the processor is configured to receive the data by receiving the data during a time period comprising a plurality of time windows, and wherein the processor is configured to identify a second location of the plurality of locations with data for at least one transaction in a number of time windows of the time period fewer than a number of the plurality of time windows; and for the second location, determine the ratio of the count of rows of the subset of rows of the second location that include a date of a fraudulent transaction to a count of rows of the plurality of rows of the second location multiplied by a size of the plurality of time windows of the time period and over a size of the number of time windows with data for at least one transaction.

At least one aspect of a technical solution to the problems described herein is directed to a method for maintaining data integrity. The method can include receiving, by a processor from one or more computing devices, data regarding a plurality of transactions performed at a plurality of locations; generating, by the processor from the data, a data structure, wherein the data structure comprises a plurality of rows, each row corresponding to a different transaction of the plurality of transactions and including an identification of a location, an identification of a card that performed the transaction at the location, and a date of the transaction at the location, and wherein a subset of the plurality of rows each comprise an indication of a fraudulent transaction subsequent to the date of the transaction of the row; for each of the plurality of locations, determining, by the processor, a ratio of a count of rows of the subset of rows for the location that each include a date of a fraudulent transaction to a count of rows of the plurality of rows for the location; determining, by the processor, a location from the plurality of locations is a point of compromise based on the ratio for the location; and generating, by the processor, a record comprising a stored association between an identification of the location and an identification indicating a point of compromise responsive to the determination.

In some embodiments, the data structure is a standard query language (SQL) table or a Python/R dataframe. In some embodiments, determining the location is a point of compromise based on the ratio of the location comprises comparing, by the processor, the ratio of the location with a ratio threshold; and determining, by the processor, the location is a point of compromise responsive to the location exceeding the ratio threshold. In some embodiments, the method comprises storing, by the processor in memory, a plurality of ratio thresholds, each of the plurality of ratio thresholds corresponding to a different set of locations of the plurality of locations, wherein comparing the ratio of the location with the ratio threshold comprises comparing the ratio of the location with the ratio threshold corresponding to the location.

In some embodiments, receiving the data comprises receiving, by the processor, the data during a time period, and determining the location is a point of compromise based on the ratio for each of the plurality of locations comprises selecting, by the processor, one or more of the plurality of locations based on the ratios of the one or more locations exceeding a ratio threshold; for each of the selected one or more locations, calculating, by the processor, a compromise threshold based on rows of the data structure that each correspond to a transaction and contain the identification of the location, an indication of a fraudulent transaction subsequent to the transaction, and a date of the transaction within a first set of two or more time windows of the time period; and comparing, by the processor and to the compromise threshold and for each of one or more time windows of the time period subsequent to the first set of two or more time windows of the time period, a second count of rows of the data structure that each correspond to a transaction and contain the identification of the location, a date of a fraudulent transaction subsequent to the transaction, and a date of the transaction within the time window of the one or more time windows, wherein determining the location is a point of compromise comprises determining, by the processor, the location is a point-of-comprise responsive to determining the second count of rows for the location exceeds the compromise threshold for the location.

In some embodiments, the method includes, for each of the selected one or more locations, determining, by the processor, a frequency of time windows based on a number of time windows in which the second count of rows of the time window for the location exceeds one or more compromise thresholds for the location; and identifying, by the processor, a defined number of locations that correspond with the highest frequencies, the defined number of locations comprising the location.

At least one aspect of a technical solution to the problems described herein is directed to a non-transitory computer-readable storage medium. The non-transitory computer-readable storage medium can have instructions embodied thereon. The instructions can be executable by one or more processors to perform a method. The method can include receiving, from one or more computing devices, data regarding a plurality of transactions performed at a plurality of locations; generating, from the data, a data structure, wherein the data structure comprises a plurality of rows, each row corresponding to a different transaction of the plurality of transactions and including an identification of a location, an identification of a card that performed the transaction at the location, and a date of the transaction at the location, and wherein a subset of the plurality of rows each comprise an indication of a fraudulent transaction subsequent to the date of the transaction of the row; for each of the plurality of locations, determining a ratio of a count of rows of the subset of rows for the location that each include a date of a fraudulent transaction to a count of rows of the plurality of rows for the location; determining a location from the plurality of locations is a point of compromise based on the ratio for the location; and generating a record comprising a stored association between an identification of the location and an identification indicating a point of compromise responsive to the determination.

In some embodiments, the data structure is a standard query language (SQL) table or a Python/R dataframe. In some embodiments, determining the location is a point of compromise based on the ratio of the location comprises comparing the ratio of the location with a ratio threshold; and determining the location is a point of compromise responsive to the location exceeding the ratio threshold. In some embodiments, the indication of the fraudulent transaction comprises a date of the fraudulent transaction.

These and other aspects and implementations are discussed in detail herein. The detailed description includes illustrative examples of various aspects and implementations and provides an overview or framework for understanding the nature and character of the claimed aspects and implementations. The drawings provide illustration and a further understanding of the various aspects and implementations and are incorporated in and constitute a part of this specification.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “computing device” or “component” encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the computing devices 102-106 or the compromise detection system 108) to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks. The processor and the memory can be supplemented by, or incorporated in, special purpose logic circuitry.

While operations are depicted in the drawings in a particular order, such operations are not required to be performed in the particular order shown or in sequential order, and all illustrated operations are not required to be performed. Actions described herein can be performed in a different order. The separation of various system components does not require separation in all implementations, and the described program components can be included in a single hardware or software product.

The phraseology and terminology used herein is for the purpose of description and should not be regarded as limiting. Any references to implementations or elements or acts of the systems and methods herein referred to in the singular may also embrace implementations including a plurality of these elements, and any references in plural to any implementation or element or act herein may also embrace implementations including only a single element. Any implementation disclosed herein may be combined with any other implementation or embodiment.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A system for maintaining data integrity, comprising:
a network interface; and
a processor coupled to memory, the processor configured to:
receive, via the network interface and from one or more computing devices, data regarding a plurality of transactions performed at a plurality of locations;
generate, from the data, a data structure,
wherein the data structure comprises a plurality of rows, each row corresponding to a different transaction of the plurality of transactions and including an identification of a location, an identification of a card that performed the transaction at the location, and a date of the transaction at the location, and
wherein a subset of the plurality of rows each comprise an indication of a fraudulent transaction subsequent to the date of the transaction of the row;
for each of the plurality of locations, determine a ratio of a count of rows of the subset of rows for the location that each include an indication of a fraudulent transaction to a count of rows of the plurality of rows for the location;
determine a location from the plurality of locations is a point of compromise based on the ratio for the location; and
generate a record comprising a stored association between an identification of the location and an identification indicating a point of compromise responsive to the determination.

2. The system of claim 1, wherein the data structure is a standard query language (SQL) table or a Python/R dataframe.

3. The system of claim 1, wherein the processor is configured to determine the location is a point of compromise based on the ratio of the location by:
comparing the ratio of the location with a ratio threshold; and
determining the location is a point of compromise responsive to the location exceeding the ratio threshold.

4. The system of claim 3, wherein the processor is configured to:
store a plurality of ratio thresholds, each of the plurality of ratio thresholds corresponding to a different set of locations of the plurality of locations,
wherein the processor is configured to compare the ratio of the location with the ratio threshold based on the ratio threshold corresponding to the location.

5. The system of claim 1, wherein the processor is configured to receive the data by receiving the data during a time period, and wherein the processor is configured to determine the location is a point of compromise based on the ratio for each of the plurality of locations by:
selecting one or more of the plurality of locations based on the ratios of the one or more locations exceeding a ratio threshold; and
for each of the selected one or more locations:
calculating a compromise threshold based on rows of the data structure that each correspond to a transaction and contain the identification of the location, an indication of a fraudulent transaction subsequent to the transaction, and a date of the transaction within a first set of two or more time windows of the time period; and
comparing, to the compromise threshold and for a time window of the time period subsequent to the first set of two or more time windows of the time period, a second count of rows of the data structure that each correspond to a transaction and contain the identification of the location, an indication of a fraudulent transaction subsequent to the transaction, and a date of the transaction within the time window of the one or more time windows,
wherein the processor is configured to determine the location is a point of compromise responsive to determining the second count of rows for the location exceeds the compromise threshold for the location.

6. The system of claim 5, wherein the processor is configured to:
for each of the selected one or more locations, determine a frequency of time windows based on a number of time windows in which a count of rows that correspond with fraudulent transactions at the location within the time windows exceeds one or more compromise thresholds for the location; and
identify a defined number of locations that correspond with the highest frequencies, the defined number of locations comprising the location.

7. The system of claim 5, wherein the processor is configured to calculate a second compromise threshold for a second location of the plurality of locations by:
calculating a first count of a number of rows of the data structure that each correspond to a transaction and contain the identification of the second location, an indication of a fraudulent transaction subsequent to the transaction, and a date of the transaction within a first time window of the plurality of time windows;
calculating a second count of a number of rows of the data structure that each correspond to a transaction and contain the identification of the second location, an indication of a fraudulent transaction subsequent to the transaction, and a date of the transaction within a second time window of the plurality of time windows; and
calculating an average of the first count and the second count.

8. The system of claim 7, wherein the processor is configured to calculate the threshold by:
calculating a standard deviation based at least on the first count and the second count; and
calculating the second compromise threshold based at least on the calculated average and standard deviation.

9. The system of claim 8, wherein the processor is configured to calculate the second compromise threshold based further on a predetermined value.

10. The system of claim 1, wherein the processor is configured to receive the data by receiving the data during a time period comprising a plurality of time windows, and wherein the processor is configured to:
identify a second location of the plurality of locations with data for at least one transaction in a number of time windows of the time period fewer than a number of the plurality of time windows; and
for the second location, determine the ratio of the count of rows of the subset of rows of the second location that include an indication of a fraudulent transaction to a count of rows of the plurality of rows of the second location over a size of the number of time windows with data for at least one transaction.

11. The system of claim 1, wherein the processor is configured to receive the data by receiving the data during a time period comprising a plurality of time windows, and wherein the processor is configured to:
identify a second location of the plurality of locations with data for at least one transaction in a number of time windows of the time period fewer than a number of the plurality of time windows; and
for the second location, determine the ratio of the count of rows of the subset of rows of the second location that include an indication of a fraudulent transaction to a count of rows of the plurality of rows of the second location multiplied by a size of the plurality of time windows of the time period and over a size of the number of time windows with data for at least one transaction.

12. A method, comprising:
receiving, by a processor from one or more computing devices, data regarding a plurality of transactions performed at a plurality of locations;
generating, by the processor from the data, a data structure,
wherein the data structure comprises a plurality of rows, each row corresponding to a different transaction of the plurality of transactions and including an identification of a location, an identification of a card that performed the transaction at the location, and a date of the transaction at the location, and
wherein a subset of the plurality of rows each comprise an indication of a fraudulent transaction subsequent to the date of the transaction of the row;
for each of the plurality of locations, determining, by the processor, a ratio of a count of rows of the subset of rows for the location that each include an indication of a fraudulent transaction to a count of rows of the plurality of rows for the location;
determining, by the processor, a location from the plurality of locations is a point of compromise based on the ratio for the location; and
generating, by the processor, a record comprising a stored association between an identification of the location and an identification indicating a point of compromise responsive to the determination.

13. The method of claim 12, wherein the data structure is a standard query language (SQL) table or a Python/R dataframe.

14. The method of claim 12, wherein determining the location is a point of compromise based on the ratio of the location comprises:
comparing, by the processor, the ratio of the location with a ratio threshold; and
determining, by the processor, the location is a point of compromise responsive to the location exceeding the ratio threshold.

15. The method of claim 14, comprising:
storing, by the processor in memory, a plurality of ratio thresholds, each of the plurality of ratio thresholds corresponding to a different set of locations of the plurality of locations,
wherein comparing the ratio of the location with the ratio threshold comprises comparing the ratio of the location with the ratio threshold corresponding to the location.

16. The method of claim 12, wherein receiving the data comprises receiving, by the processor, the data during a time period, and
wherein determining the location is a point of compromise based on the ratio for each of the plurality of locations comprises:
selecting, by the processor, one or more of the plurality of locations based on the ratios of the one or more locations exceeding a ratio threshold;
for each of the selected one or more locations:
calculating, by the processor, a compromise threshold based on rows of the data structure that each correspond to a transaction and contain the identification of the location, an indication of a fraudulent transaction subsequent to the transaction, and a date of the transaction within a first set of two or more time windows of the time period; and
comparing, by the processor and to the compromise threshold and for each of one or more time windows of the time period subsequent to the first set of two or more time windows of the time period, a second count of rows of the data structure that each correspond to a transaction and contain the identification of the location, an indication of a fraudulent transaction subsequent to the transaction, and a date of the transaction within the time window of the one or more time windows,
wherein determining the location is a point of compromise comprises determining, by the processor, the location is a point-of-comprise responsive to determining the second count of rows for the location exceeds the compromise threshold for the location.

17. The method of claim 16, comprising:
for each of the selected one or more locations, determining, by the processor, a frequency of time windows based on a number of time windows in which a count of rows that correspond with fraudulent transactions at the location within the time windows exceeds one or more compromise thresholds for the location; and
identifying, by the processor, a defined number of locations that correspond with the highest frequencies, the defined number of locations comprising the location.

18. A non-transitory computer-readable storage medium having instructions embodied thereon, the instructions being executable by one or more processors to perform a method, the method comprising:
receiving, from one or more computing devices, data regarding a plurality of transactions performed at a plurality of locations;
generating, from the data, a data structure,
wherein the data structure comprises a plurality of rows, each row corresponding to a different transaction of the plurality of transactions and including an identification of a location, an identification of a card that performed the transaction at the location, and a date of the transaction at the location, and
wherein a subset of the plurality of rows each comprise an indication of a fraudulent transaction subsequent to the date of the transaction of the row;
for each of the plurality of locations, determining a ratio of a count of rows of the subset of rows for the location that each include an indication of a fraudulent transaction to a count of rows of the plurality of rows for the location;
determining a location from the plurality of locations is a point of compromise based on the ratio for the location; and
generating a record comprising a stored association between an identification of the location and an identification indicating a point of compromise responsive to the determination.

19. The non-transitory computer-readable storage medium of claim 18, wherein the data structure is a standard query language (SQL) table or a Python/R dataframe.

20. The non-transitory computer-readable storage medium of claim 18, wherein determining the location is a point of compromise based on the ratio of the location comprises:
comparing the ratio of the location with a ratio threshold; and
determining the location is a point of compromise responsive to the location exceeding the ratio threshold.
